(19) United States
(12) Patent Application Publication
(10) Pub. No.: US 2008/0044222 A1
(43) Pub. Date: Feb. 21, 2008

(54) 'F' -shaped fastening device

(75) Inventor: Wen-Tsung Hsiao, Taoyuan County (TW)

Correspondence Address: TROXELL LAW OFFICE PLLC, SUITE 1404, 5205 LEESBURG PIKE, FALLS CHURCH, VA, 22041, US

(73) Assignee: SPEED TECH CORP., Taoyuan County (TW)

(21) Appl. No.: 11/505,861

(22) Filed: Aug. 18, 2006

(51) Int. Cl. F16G 11/10

(52) U.S. Cl. 403/353

(57) ABSTRACT

A fastening device is shaped like ‘F’. The fastening device is positioned precisely and is prevented from being inserted too deep on inserting it into a seat. In addition, the structure of the seat is strengthened.

### FIELD OF THE INVENTION

The present invention relates to a fastening device; more particularly, relates to positioning the device precisely, avoiding inserting the device too deep, and strengthening a structure of a seat inserted.

### DESCRIPTION OF THE RELATED ART

A positioning member 3 of a prior art interfering with a plastic seat 4, as shown in FIG. 6 and FIG. 7, comprises a wall plate 31 and a bottom plate 32 connected to each other vertically. The wall plate 31 has a hook 33 at a proper position of each of two opposite sides of the wall plate 31. When assembling the positioning member 3 and the plastic seat 4, as shown in FIG. 8 and FIG. 9, the wall plate 31 is inserted into a slot 41 at each of two opposite sides of the plastic seat 4 to interfere the hooks 33 at two sides of the wall plate with two side walls of the slot 41 and thus the positioning member 3 is combined with the plastic seat 4

Although the positioning member 3 and the plastic seat 4 are combined by interfering the two hooks 33 at two sides of the wall plate 32 with the side walls of the slot 41, the wall plate 32 of the positioning member 3 has hooks 33 only, without stopper, so that the positioning member 3 can not be positioned precisely on inserting the wall plate 32 into the slot 41, even be over-inserted sometimes. Consequently, the bottom plates 31 of the positioning members 3 may not be set at the same position level. In addition, the width of the hooks 33 at two sides of the wall plate 32 are summed with the thickness of the side walls of the slot 41; so, since the hooks 33 are protruding out to effectively interfere with the side walls of the slot 41, the thickness of the side walls of the slot 41 are thus reduced and the structure of the plastic seat 4 is weakened. Hence, the prior art does not fulfill users requests on actual use.

### SUMMARY OF THE INVENTION

The main purpose of the present invention is to position a fastening device precisely on assembling a main frame and a plastic seat while avoiding over-inserting the main frame and strengthening the plastic seat structure by a coordination of an interfering part at a side of a first plate and a locked part of a slot.

To achieve the above purpose, the present invention is a F-shaped fastening device, comprising a main frame. The main frame comprises a main body as a flat plate; and an interfering part being extended out at a side of the main body, where the interfering part comprises a stopping surface and a hook near the stopping surface; the main body is further connected vertically with a second plate at an end of the first plate; and the first plate of the main body is inserted into a plastic seat to obtain a precise positioning while over-inserting is avoided and a structure of the plastic seat is strengthened on assembling the main frame and the plastic seat by coordinating the interfering part with the slot. Accordingly, a novel F-shaped fastening device is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is the front view showing the first preferred embodiment according to the present invention;

FIG. 2 is the perspective view showing the first preferred embodiment;

FIG. 3 is the perspective view showing the state of use;

FIG. 4 is the cross-sectional view of the state of use;

FIG. 5 is the front view showing the second preferred embodiment;

FIG. 6 is the perspective view of the prior art;

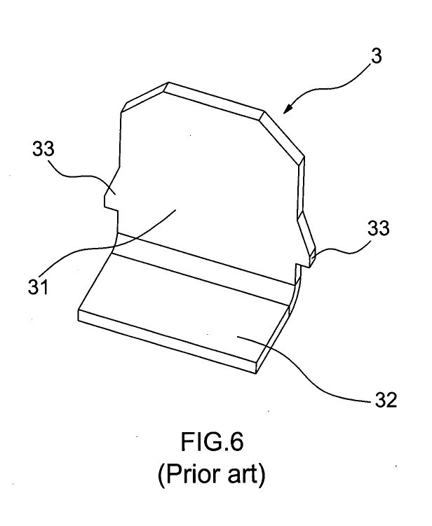

FIG. 7 is the front view of the prior art;

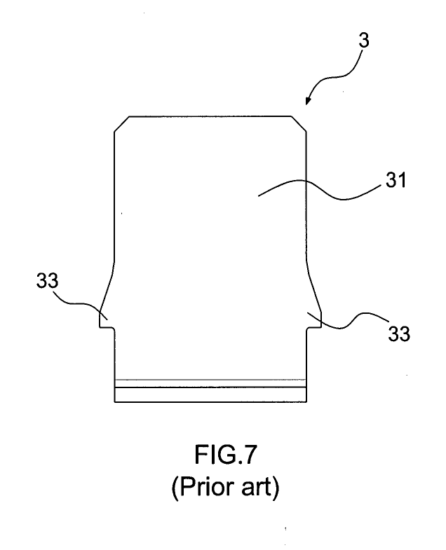

FIG. 8 is the state-of-use view of the prior art; and

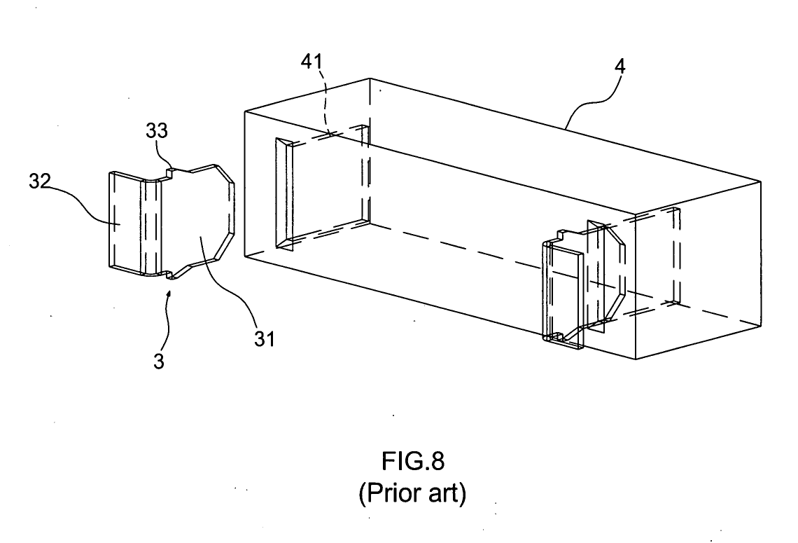

FIG. 9 is the sectional view of the state of use of the prior art.

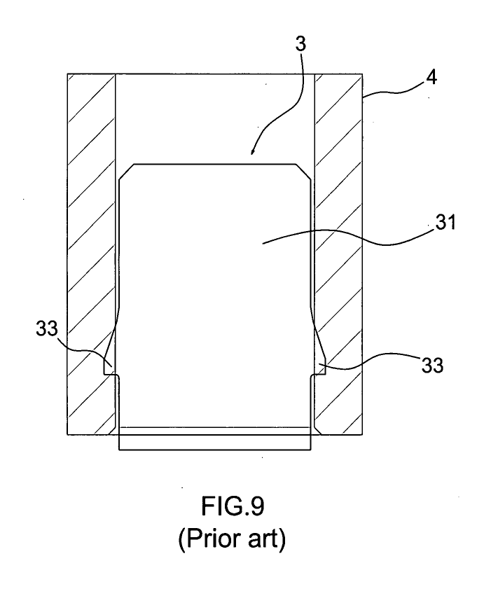

### DESCRIPTIONS OF THE PREFERRED EMBODIMENTS

The following descriptions of the preferred embodiments are provided to understand the features and the structures of the present invention.

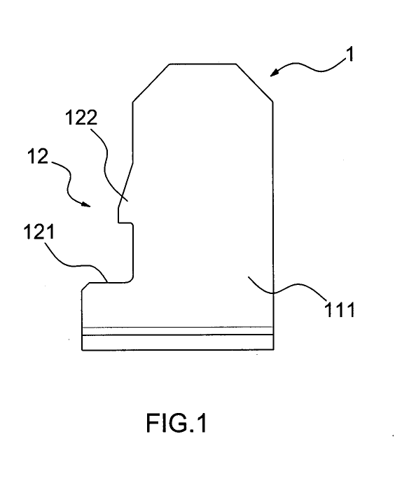

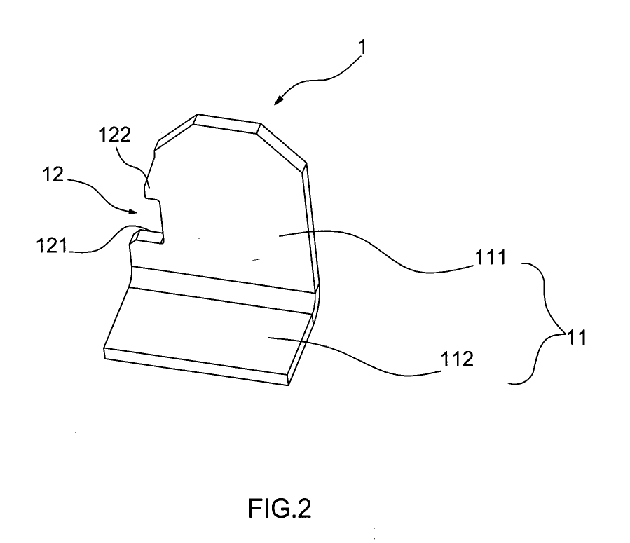

Please refer to FIG. 1 and FIG. 2, which are a front view and a perspective view showing a first preferred embodiment according to the present invention. As shown in the figures, the present invention is a F-shaped fastening device, comprising a main frame 1. The main frame 1 is a metal plate and comprises a main body 11 and an interfering part 12. The main body 11 comprises a first plate 111. The interfering part 12 is set at a side of the first plate 11, comprising a stopping surface 121 set at a side verge; and a hook 122. The first plate 111 is further extended out an extension for a change in the connection state, for example, to connect to a second plate 112 or a part in any shape. Thus, a novel F-shaped fastening device is obtained.

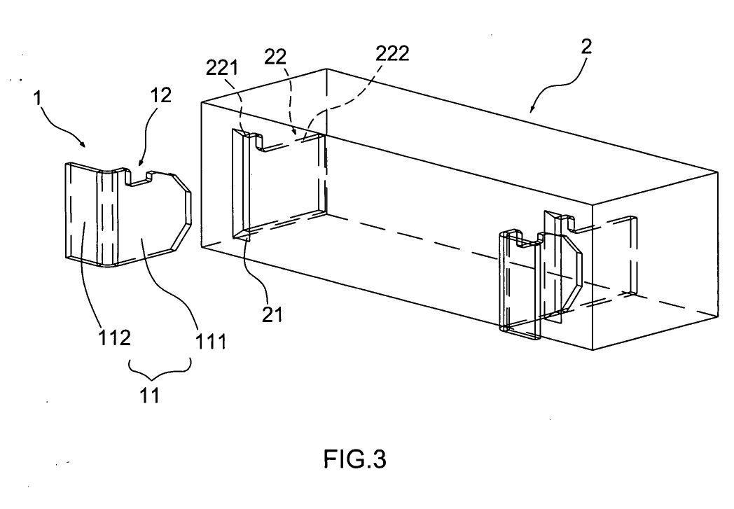

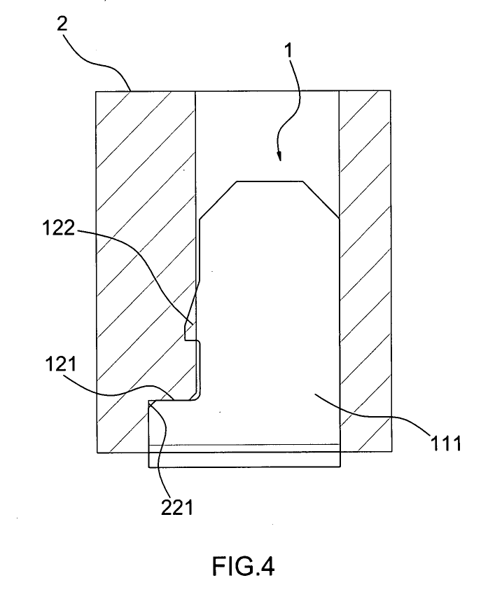

Please refer to FIG. 3 and FIG. 4, which are a perspective view and a cross-sectional view showing a state of use. As shown in the figures, the present invention is set for a slot 21 at each of two sides of a plastic seat 2. The slot 21 has a locked part 22 on a side wall and comprises a slot mouth 221 at an opening of the slot 21; and a contacting surface 222 extended into the slot 21 from the slot mouth 221, where a steep is formed with the slot mouth 221 and the contacting surface 222.

When assembling the main frame 1 and the plastic seat 2, the first plate 111 of the main body 11 is inserted into the slot 21 of the plastic seat 2 to butt the stopping surface 121 of the interfering part 12 against the slot mouth 221 of the locked part 22 and to interfere the hook 122 of the interfering part 12 with the contacting surface 222 of the locked part 22. By doing so, a precise positioning is obtained on assembling the main frame 1 and the plastic seat 2 while preventing the main frame 1 from being inserted too deep. And, by the coordination of the interfering part 12 at a side of the first plate 111 and the locked part 22 on a side wall of the slot 21, the structure of the plastic seat 2 is strengthened.

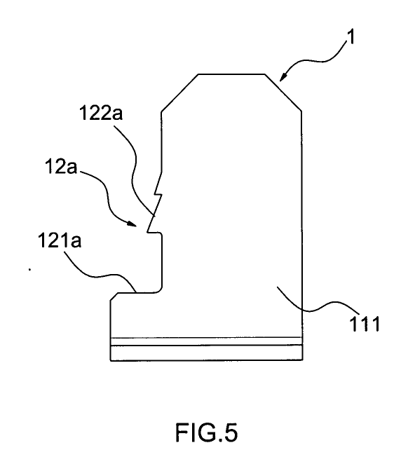

Please refer to FIG. 5, which is a front view showing a second preferred embodiment. As shown in the figure, an interfering part 12a according to the present invention comprises a stopping surface 121a at a side verge of a first plate 111; and a plurality of continuous hooks 122a near the stopping surface 121a.

To sum up, the present invention is a F-shaped fastening device, where, by coordinating an interfering part at a side of a first plate with a locked part of a slot, a precise positioning is obtained on assembling a main frame and a plastic seat, and a structure of the plastic seat is strengthened, while prevent the main frame from being inserted too deep.

The preferred embodiments herein disclosed are not intended to unnecessarily limit the scope of the invention. Therefore, simple modifications or variations belonging to the equivalent of the scope of the claims and the instructions disclosed herein for a patent are all with in the scope of the present invention.

1-8. (canceled)

9. An F-shaped fastening device comprising: a main frame having:
a) a main body having:
i) a first plate; and
ii) a second plate having a second plate connecting end connected to a first plate connecting end of the first plate, the first plate is positioned at a predetermined angle relative to the second plate, the first plate connecting end of the first plate has a width equal to a width of the second plate connecting end of the second plate, two lateral first edges of the first plate are positioned at the predetermined angle relative to two lateral second edges of the second plate, an end of one of the two lateral first edges of the first plate aligning with an end of each of the two lateral second edges of the second plate; and
b) an interfering part located on one of the two lateral first edges of the. first plate of the main body.

10. The F-shaped fastening device according to claim 9, wherein the main frame is made of metal.

11. The F-shaped fastening device according to claim 9, wherein the interfering part has a stopping surface and a hook.

12. The F-shaped fastening device according to claim 9, wherein the interfering part has a stopping surface and a plurality of hooks.

13. The F-shaped fastening device according to claim 9, wherein widths of the first plate and the second plate are greater than thicknesses thereof.

14. The F-shaped fastening device according to claim 9, wherein the first plate is positioned at a right angle relative to the second plate.
